(19) United States
(12) Patent Application Publication
(10) Pub. No.: US 2025/0318968 A1
(43) Pub. Date: Oct. 16, 2025

(54) STEP ASCENDING/ DESCENDING DEVICE

(71) Applicant: ACCESS ENGINEERING CO., LTD., Sagamihara-shi, Kanagawa (JP)

(72) Inventor: Kenichi NAKAMURA, Sagamihara-shi, Kanagawa (JP)

(73) Assignee: ACCESS ENGINEERING CO., LTD., Sagamihara-shi, Kanagawa (JP)

(21) Appl. No.: 18/863,190

(22) PCT Filed: Apr. 28, 2023
(86) PCT No.: PCT/JP2023/016806

§ 371 Date: Nov. 5, 2024

(30) Foreign Application Priority Data
Jan. 31, 2023 (JP) 2023-012797

(51) Int. Cl. A61G 5/06; A61G 5/04; B60B 19/00

(52) U.S. Cl. CPC A61G 5/06; A61G 5/04; B60B 19/003

(57) ABSTRACT

Provided is a step ascending/descending device, including: traveling units (3), each of which includes three traveling wheels (31) arranged at equal angular intervals around a rotary shaft of the traveling units (3), and which are configured to revolve the traveling wheels (31) around the rotary shaft, each of the traveling wheels (31) being configured to travel on a floor surface by being rotated on an own axis of the traveling wheel (31); a device frame (2) including at least a pair of the traveling units (3) provided on right and left sides in the device frame (2), respectively; a traveling drive source (8) configured to rotationally drive the traveling wheels (31); an ascending/descending drive source (9) configured to drive and revolve the traveling units (3); and a traveling controller (7) configured to control operations of the traveling drive source (8) and the ascending/descending drive source (9), the step ascending/descending device being configured to ascend and descend a step while revolving the traveling units (3), wherein, at the time of driving and revolving the traveling units (3), the traveling controller (7) is configured to rotationally drive the traveling wheels (31) at the same angle of rotation as a revolution angle of the traveling units (3) in a direction opposite to a revolution direction of the traveling units (3).

### TECHNICAL FIELD

The present invention relates to a step ascending/descending device, which can stably travel and move on a flat ground surface and can easily and safely ascend and descend steps such as stairs while carrying an occupant, a package, or the like.

### BACKGROUND ART

An electric wheelchair is welfare equipment that is important for an elderly person, a physically disabled person, or the like who lives independently without relying on a caregiver, and use of the electric wheelchair has become prominent in a society with rapidly aging population. Meanwhile, a general electric wheelchair can travel over relatively small steps, such as irregularities of a road surface, but cannot ascend and descend large steps, such as stairs. Thus, there is a problem in that difficulty arises in visiting a building in which it is difficult to install a lifting machine such as an elevator. Further, there is a problem in that difficulty also arises, for the same reason, when an elderly person, a physically disabled person, or the like is to move a heavy package upstairs or downstairs.

Hitherto, as a measure for solving such problems, there has been proposed a step ascending/descending device that can ascend and descend stairs while carrying an occupant or a package, as disclosed in Patent Literature 1 or Patent Literature 2.

In the step ascending/descending device disclosed in each of those literatures, traveling units each including three traveling wheels radially arranged therein are provided on right and left sides of a device frame. The three traveling wheels can each rotate on an own axis thereof to travel on a floor surface, and can also revolve around a rotary shaft of the traveling units. When the traveling units are rotationally driven around the rotary shaft as appropriate, any appropriate traveling wheel among the three traveling wheels of each of the traveling units can be brought into contact with the floor surface.

In the step ascending/descending device of Patent Literature 1 or Patent Literature 2 configured as described above, on a flat road surface, two traveling wheels among the three traveling wheels included in each of the traveling units are brought into contact with the road surface, and are rotationally driven, thereby allowing the step ascending/descending device to stably travel on the road surface. Further, in a case of ascending steps such as stairs, when any one of the three traveling wheels abuts against a riser surface of the step, the traveling units are rotationally driven to revolve the traveling wheels around the rotary shaft of the traveling units, and while a traveling wheel among the three traveling wheels, which has not been in contact with the road surface, is brought into contact with a tread on the step, the traveling unit is further rotationally driven. Accordingly, the device frame can be pulled up onto the step.

Meanwhile, in a case of descending the step, at a timing at which one of the three traveling wheels is separated from the road surface to reach a tread below a riser surface, the traveling unit is rotationally driven, and thus, a traveling wheel among the three traveling wheels, which has not been in contact with the road surface, is brought into contact with the tread below the step. Accordingly, the device frame can be lowered below the step.

### CITATION LIST

### Patent Literature

[PTL 1] JP 2012-85854 A

[PTL 2] JP 3234497 U

### DISCLOSURE OF THE INVENTION

### Problems to be Solved by the Invention

However, in the related-art step ascending/descending devices as described above, when the traveling units are rotationally driven to revolve the traveling wheels, even under a state in which rotational driving of the traveling wheels is stopped, the traveling wheels each rotate on the road surface or the tread of the step. Thus, there has been a problem in that a posture of the device frame becomes unstable at the time of ascending and descending the step. Particularly, at the time of descending the stairs, the traveling wheels may be separated from the tread along with rotational driving of the traveling unit to fall onto a tread below the riser surface, and hence it has been difficult to safely descend the stairs with an occupant or a package being carried on the device frame.

### Means for Solving the Problems

The present invention has been made in view of the problems as described above, and has an object to provide a step ascending/descending device that can stably ascend and descend steps such as stairs while carrying an occupant or a package, by using traveling units each including three traveling wheels radially arranged therein.

That is, according to the present invention, there is provided a step ascending/descending device, including: traveling units, each of which includes three traveling wheels arranged at equal angular intervals around a rotary shaft of the traveling units, and which are configured to revolve the traveling wheels around the rotary shaft, each of the traveling wheels being configured to travel on a floor surface by being rotated on an own axis of the traveling wheel, a device frame including at least a pair of the traveling units provided on right and left sides in the device frame, respectively; a traveling drive source configured to rotationally drive the traveling wheels; an ascending/descending drive source configured to drive and revolve the traveling units; and a traveling controller configured to control operations of the traveling drive source and the ascending/descending drive source, the step ascending/descending device being configured to ascend and descend a step while revolving the traveling units, wherein, at the time of driving and revolving the traveling units, the traveling controller is configured to rotationally drive the traveling wheels at the same angle of rotation as a revolution angle of the traveling units in a direction opposite to a revolution direction of the traveling units.

### Effects of the Invention

According to the present invention as described above, regarding drive control of the traveling units and the three traveling wheels included in each of the traveling units at the time of ascending and descending steps, when the traveling controller drives and revolves the traveling units, the traveling controller rotationally drives the traveling wheels at the same angle of rotation as the revolution angle of the traveling units in the direction opposite to the revolution direction. Thus, each of the traveling units can be driven to revolve while the traveling wheel stays on the tread. Accordingly, with the present invention, the traveling wheel does not unintentionally rotate on a road surface or the tread of the step, and hence it is possible to stably ascend and descend steps such as stairs while carrying an occupant or a package.

### BRIEF DESCRIPTION OF THE DRAWINGS

FIG. 1 is a schematic view for illustrating an example of an embodiment of an electric wheelchair to which a step ascending/descending device of the present invention is applied.

FIG. 2 is a schematic view for illustrating states in which the electric wheelchair according to the embodiment ascends and descends stairs.

FIG. 3 is a perspective view for illustrating an example of a traveling wheel in the embodiment.

FIG. 4 is a block diagram for illustrating a control system of the electric wheelchair according to the embodiment.

FIG. 5 is a schematic view for illustrating operations of traveling units and traveling wheels included in each of the traveling units, at the time when the electric wheelchair according to the embodiment descends from a road surface to a first step from the top of stairs.

FIG. 6 is a schematic view for illustrating operations of the traveling units and the traveling wheels included in each of the traveling units, at the time when the electric wheelchair according to the embodiment descends from the first step to a second step from the top of the stairs.

FIG. 7 is a schematic view for illustrating operations of the traveling units and the traveling wheels included in each of the traveling units, at the time when the electric wheelchair according to the embodiment ascends from a road surface to a first step from the bottom of stairs.

### MODE FOR CARRYING OUT THE INVENTION

Now, a step ascending/descending device of the present invention is described in detail with reference to the attached drawings.

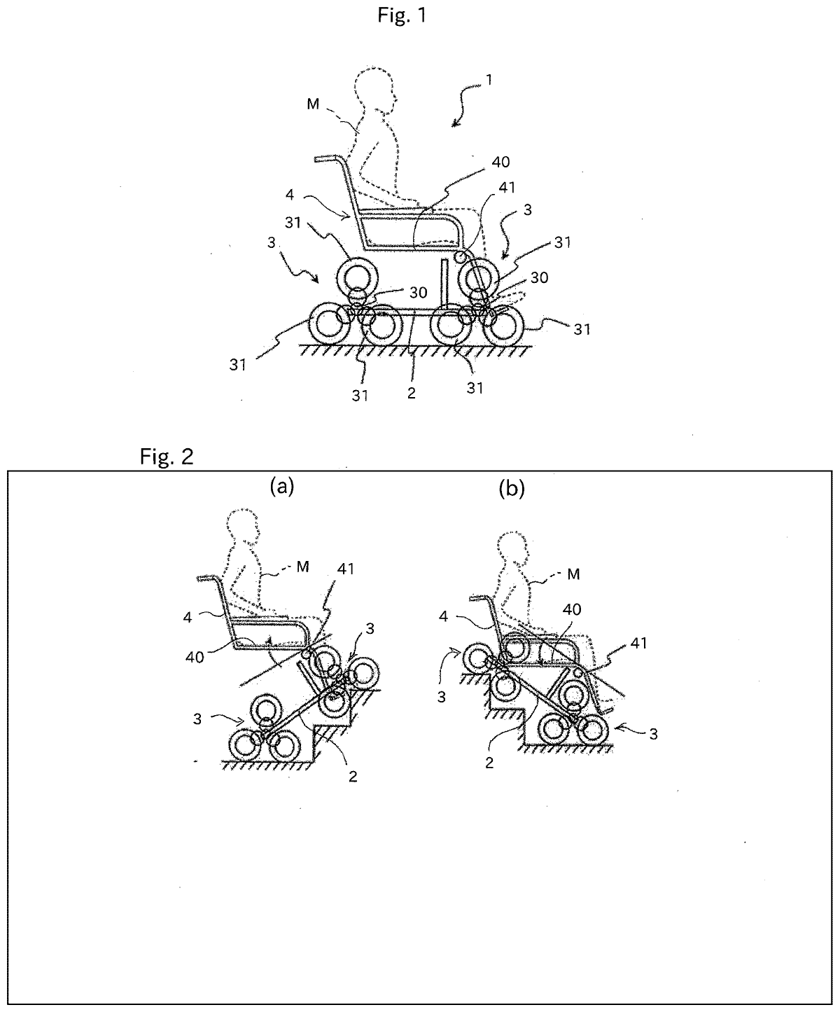

FIG. 1 is a schematic view for illustrating an embodiment in which the step ascending/descending device according to the present invention is applied to an electric wheelchair. An electric wheelchair 1 as described above is configured to travel in a front-and-rear direction and a right-and-left direction in accordance with operation by an occupant M seated on a seat surface thereof, and to travel on level ground under a state in which the occupant M is seated on the seat surface, and is further configured to be able to ascend and descend steps such as stairs.

The electric wheelchair 1 includes a device frame 2, four traveling units 3, and a seating frame 4. The four traveling units 3 are provided on right, left, front, and rear sides of the device frame 2. The seating frame 4 is provided so as to be tiltable with respect to the device frame 2, and has a seat surface 40 on which the occupant M is to be seated. The seating frame 4 is rotatably coupled to the device frame 2 through a support shaft 41, and is connected to the device frame 2 through intermediation of an actuator (not shown). An angle of connection of the seating frame 4 with respect to the device frame 2 can be freely adjusted by extension and contraction of the actuator. Further, the device frame 2 is provided with an inclination sensor (not shown) that detects an inclination of the device frame 2 with respect to a horizontal direction.

With this configuration, as illustrated in part (a) and part (b) of FIG. 2, in a case in which the device frame 2 is inclined with respect to the horizontal direction while ascending or descending a slope or steps, an angle of the inclination is grasped from a signal of the inclination sensor, and the extension and contraction of the actuator are controlled based on the signal. Thus, the angle of connection of the seating frame 4 with respect to the device frame 2 can be freely changed. Accordingly, even in a case of ascending or descending the slope or the steps under the state in which the occupant M is seated on the seat surface 40, the seat surface 40 can always be kept horizontal regardless of the inclination of the device frame 2, and hence a relief of the occupant M can be ensured.

Next, the four traveling units 3 provided to the device frame 2 are described.

Each of the traveling units 3 includes three traveling wheels 31 radially arranged around each of drive shafts 30 of the traveling units 3, and can revolve the three traveling wheels 31 around the drive shaft 30. The three traveling wheels 31 are connected, through intermediation of a reduction gear, to a motor serving as a traveling drive source, and are rotationally driven at the same speed in the same direction. Further, a motor serving as an ascending/descending drive source is connected to each of the drive shafts 30 of the traveling units 3, and drives and revolves each of the traveling units 3 to enable one or two traveling wheels 31 among the three traveling wheels 31 to be selectively brought into contact with a road surface, such as a ground surface or a floor surface. In addition, each of the drive shafts 30 of the traveling units 3 can appropriately switch between the driving and revolving, stopping, and a free rotation.

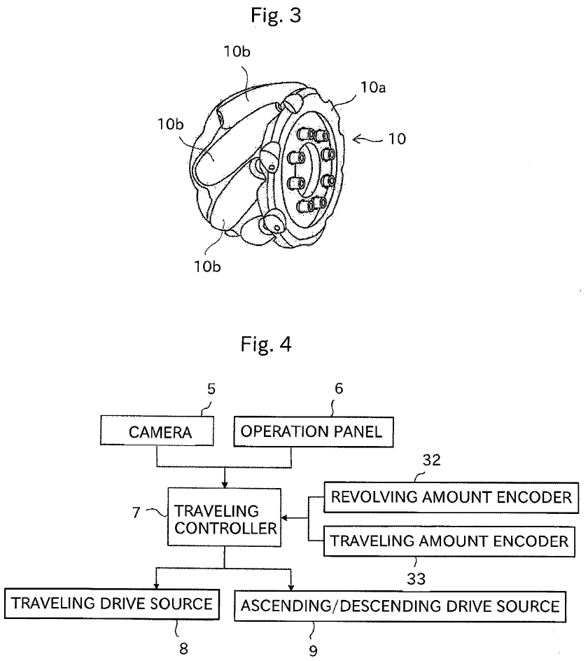

The electric wheelchair 1 is required to freely change a traveling direction thereof in accordance with driving operation by the occupant, and hence it is required that, among the traveling units 3, at least two traveling units 3 provided on the front side of the device frame 2 or at least two traveling units 3 provided on the rear side of the device frame 2 have a steering mechanism. Meanwhile, when all of the three traveling wheels 31 included in each of the traveling units 3 are configured as so-called omnidirectional wheels, the steering mechanism may be omitted. As the omnidirectional wheel, for example, a Mecanum wheel 10 illustrated in FIG. 3 may be used. The Mecanum wheel 10 is formed by arranging a plurality of sub-rollers 10b on an outer peripheral surface of a traveling wheel main body 10a that rotates. The sub-rollers 10b each have a rotary shaft that is inclined at 45 degrees with respect to a rotary shaft of the traveling wheel main body 10a. When the traveling wheel main body 10a is rotationally driven, the Mecanum wheel 10 itself tends to advance in a direction of 45 degrees oblique to a rotation direction of the traveling wheel main body 10a.

The Mecanum wheels 10 are arranged in each of the traveling units 3 so that the rotary shaft of each of the sub-rollers 10b is directed to a center of the device frame 2. Accordingly, for example, when a rotation direction of the Mecanum wheels 10 of the traveling units 3 located on the front side of the device frame 2 and a rotation direction of the Mecanum wheels 10 of the traveling units 3 located on the rear side of the device frame 2 are different from each other, the device frame can be moved laterally in the right-and-left direction. Further, a rotation direction of the Mecanum wheels 10 of the traveling units 3 located on the right side of the device frame 2 and a rotation direction of the Mecanum wheels 10 of the traveling units 3 located on the left side therein are different from each other, the device frame can be turned on the spot. As described above, when all of the three traveling wheels 31 included in each of the traveling units are configured as the Mecanum wheels 10, and only the rotation direction of the traveling wheels is controlled, the device frame can be freely moved in the front-and-rear direction and the right-and-left direction, moved in an oblique direction, and turned. Motion control of a robot carriage using Mecanum wheels 10 is well known, and thus, detailed description thereof is omitted herein.

FIG. 4 is a block diagram for illustrating a control system regarding traveling of the electric wheelchair 1. The device frame 2 is provided with a camera 5 that captures an image on a front side of the electric wheelchair 1, while the seating frame 4 is provided with an operation panel 6 that allows the occupant M to input a direction to advance. A signal transmitted from each of the camera 5 and the operation panel 6 is input to a traveling controller 7. Further, the drive shaft 30 of the traveling units 3 is provided with a revolving amount encoder 32 that detects a rotation amount of the drive shaft 30, and a rotary shaft of the traveling wheel 31 is provided with a traveling amount encoder 33 that detects a rotation amount of the traveling wheel 31. The traveling controller 7 is implemented by a computer including MPU, and executes a predetermined traveling program stored in a memory in advance, to process a signal input from each of the camera 5, the operation panel 6, the revolving amount encoder 32, and the traveling amount encoder 33, and to then transmit a drive signal to the traveling drive source 8 and the ascending/descending drive source 9. Accordingly, revolving, stopping, and a free rotation of the traveling units 3 are controlled, and rotational driving and stopping of the traveling wheels 31 included in the traveling units 3 are also controlled.

Further, the traveling controller 7 analyses an image captured by the camera 5, and as a result, step information, such as a starting position of the stairs, a height of a riser surface and a length of a tread for each step of the stairs, and an edge of the step of the stairs, can be detected. In this case, when a laser beam is radiated forward of the electric wheelchair 1, and a distance to an object is measured based on the laser beam projected within the image captured by the camera 5, information such as a more accurate length can be detected. Further, the traveling controller 7 detects the edge of the step of the stairs, and thus, can determine whether or not the electric wheelchair 1 faces the step. Meanwhile, the traveling controller 7 detects information on a travel distance of each of the traveling wheels 31 on the road surface, from a detection signal of the traveling amount encoder 33. Accordingly, the traveling controller 7 grasps a position of each of the traveling wheels 31 with respect to the step of the stairs. A function capable of detecting those pieces of information is hereinafter referred to as “information detection section.”

Means for detecting the starting position of the stairs, and the height of the riser surface and the length of the tread for each step of the stairs is not limited to the analysis of the image captured by the camera 5 as described above, but various sensors, such as a laser range finder, and an optical type or contact type sensor, may also be used.

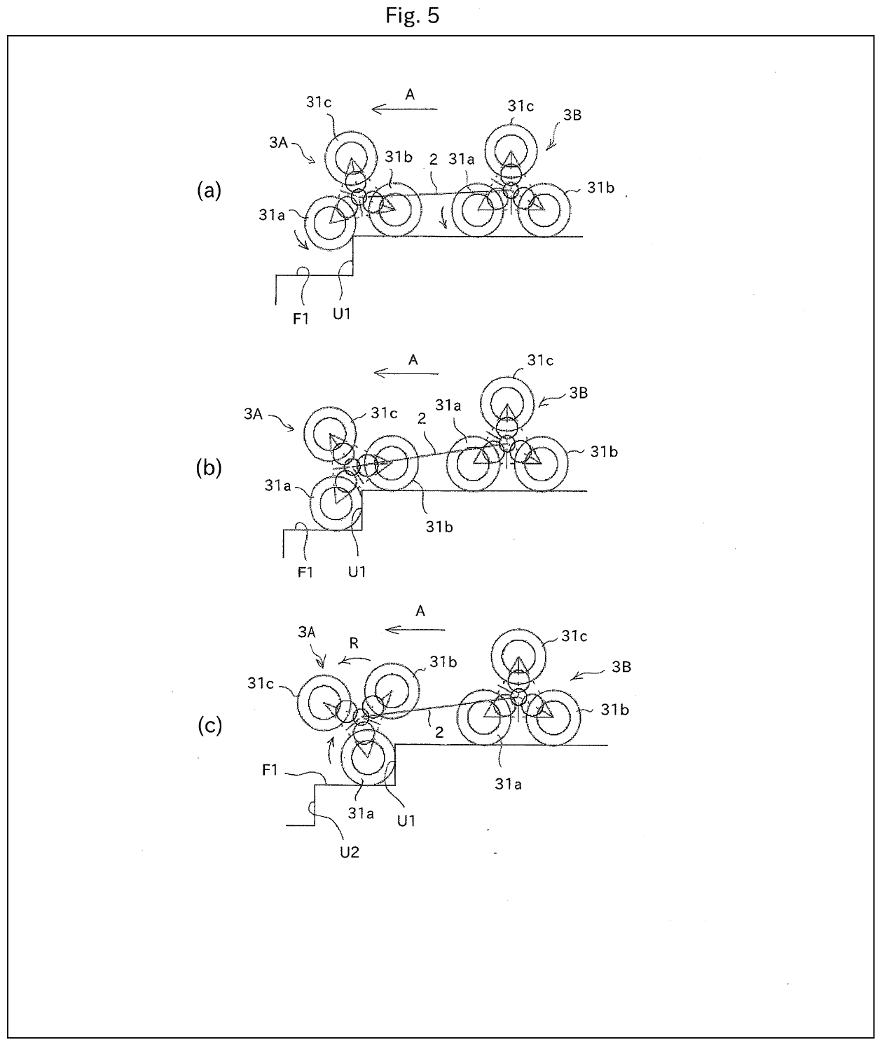

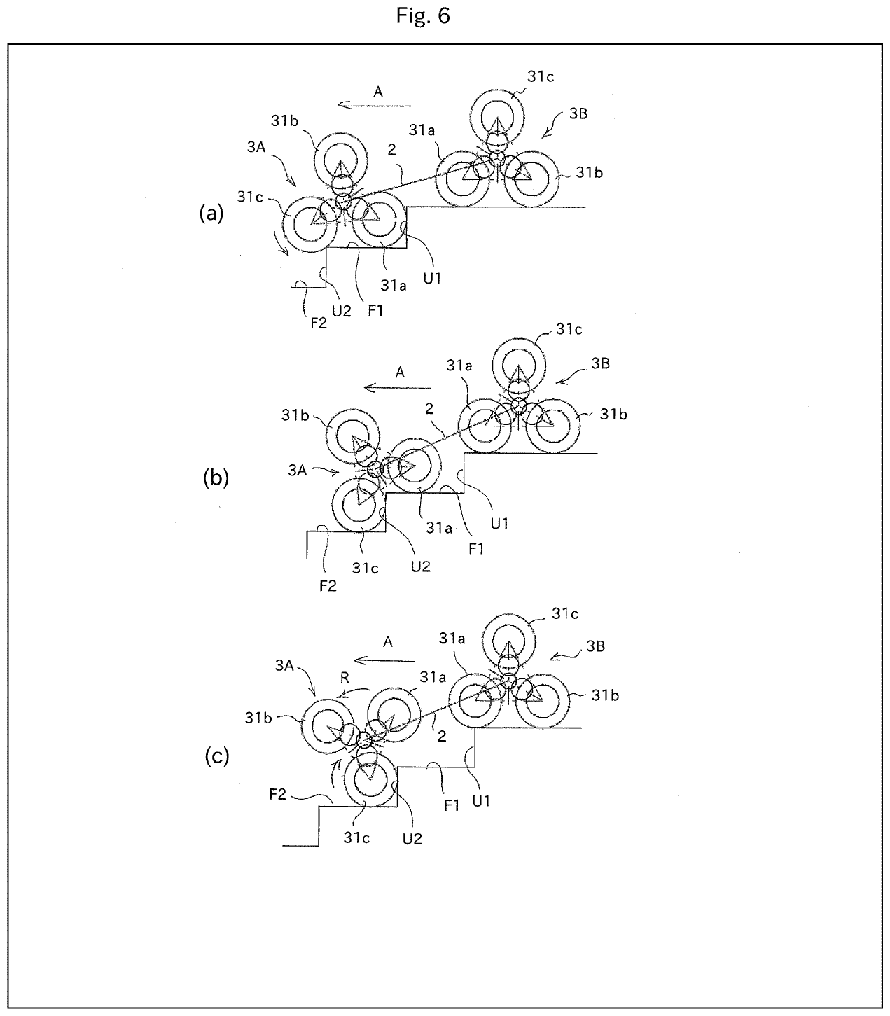

FIG. 5 and FIG. 6 are schematic views for each illustrating states of traveling units 3A and 3B and traveling wheels 31 included in each of the traveling units 3A and 3B at the time when the electric wheelchair 1 of this embodiment descends the stairs.

FIG. 5 shows states immediately before the device frame 2 descends from a flat road surface to a first step from the top of the stairs. As illustrated in part (a) of FIG. 5, in each of the traveling units 3A and 3B provided on the front side and the rear side of the device frame 2, respectively, two traveling wheels 31 are in a state of being in contact with the road surface, and with each of the traveling wheels 31 being rotationally driven, the electric wheelchair 1 is traveling forward on the road surface in a direction of the arrow A in FIG. 5. At this time, the traveling controller 7 detects an edge of the step by the information detection section, and controls traveling of the electric wheelchair 1 so that the electric wheelchair 1 faces the edge. Further, under such a state, the drive shafts 30 of the traveling units 3 are in a state of a free rotation, but with two traveling wheels 31a and 31b included in each of the traveling units 3 being brought into contact with the road surface, the traveling units 3 are in a stable state without revolving. When the leading traveling wheel 31a of the front-side traveling unit 3A is separated from the road surface and reaches the first step from the top of the stairs, due to the drive shaft 30 of the traveling unit 3A being set to the free rotation, the traveling wheel 31a descends to a tread F1 of the first step while being brought into contact with a riser surface U1 of the step (part (b) of FIG. 5).

Under such a state, when the traveling controller 7 determines that the traveling wheel 31a of the front-side traveling unit 3A has been brought into contact with the tread F1, the traveling controller 7 detects step information by the information detection section. Then, the traveling controller 7 compares a numerical value of a length of the tread F1, which is a piece of step information, with a threshold value stored in advance. This threshold value is determined based on an arrangement interval between the traveling wheel 31a and the traveling wheel 31c, and a size of the traveling wheel, and is a numerical value of a length that allows both of the traveling wheel 31a and the traveling wheel 31c to be placed on the tread. As a result of the comparison, the traveling controller 7 selects any one of traveling processing for traveling of the traveling unit on the tread F1, and revolution driving processing for moving the traveling unit to a different step, to execute the selected processing.

In part (c) of FIG. 5, the traveling controller 7 selects and executes the revolution driving processing. In the revolution driving processing, rotational driving of the traveling wheels 31 is temporarily stopped, and while a state of the traveling wheel 31a of the front-side traveling unit 3A being in contact with the tread F1 of the first step is maintained, the front-side traveling unit 3A is revolved in a direction of the arrow R. Accordingly, the traveling wheel 31b of the front-side traveling unit 3A having been in contact with the road surface at the top of the stairs is separated from the road surface, and simultaneously, the traveling wheel 31c descends toward the tread F1 of the first step, and the drive shaft 30 of the front-side traveling unit 3A moves with the traveling wheel 31a serving as a center of rotation. Thus, the device frame 2 advances in the direction of the arrow A.

Further, when the traveling controller 7 revolves the traveling unit 3A, the traveling controller 7 rotationally drives the traveling wheels 31 included in the traveling unit 3A in a direction opposite to a revolution direction of the traveling unit 3A, and by the same angle as a revolution angle of the traveling unit 3A. At the time of revolving of the traveling unit 3A, when the traveling wheels 31 included in the traveling unit 3A are kept in a stop state, the traveling wheel 31a rolls on the tread F1 in response to the revolving of the traveling unit 3A, and hence there is a risk in that the entire traveling unit 3A may be unintentionally separated from the tread F1 and fall onto a step below the tread F1. In order to avoid this risk, rotation control of the traveling wheels 31 as described above is required. Accordingly, at the time of the revolving of the traveling unit 3A, when the traveling wheel 31a is rotationally driven in the direction opposite to the revolution direction of the traveling unit 3A, the traveling wheel 31a is brought into a state of staying on the tread F1 of the first step, and hence, the traveling unit 3A can be prevented from being separated from the tread F1 and falling onto the step below the tread F1. Thus, a posture of the device frame 2 can be stabilized regardless of revolving of the traveling unit 3A. When the traveling wheel 31a is in a state of being in contact with not only the tread F1 of the first step but also the riser surface U1, the posture of the device frame 2 can be further stabilized. In addition, when the traveling unit 3A is revolved, the traveling wheels 31 included in the rear-side traveling unit 3B are brought into a state of the free rotation, and hence roll on the road surface in accordance with advancing of the device frame 2 in the direction of the arrow A.

Part (a) of FIG. 6 shows a state after executing the revolution driving processing of the traveling unit. When the traveling wheel 31c is brought into contact with the tread F1 of the first step along with the revolution driving processing of the front-side traveling unit 3A, the traveling controller 7 changes setting of the traveling unit 3A from the revolving in the direction of the arrow R to the free rotation, and stops the reverse rotation of the traveling wheels 31 included in the traveling unit 3A to rotationally drive those traveling wheels 31 in a normal direction. Accordingly, as illustrated in part (b) of FIG. 6, the traveling wheel 31c of the front-side traveling unit descends to a tread F2 of a second step from the top of the stairs while being in contact with a riser surface U2 of the second step.

After that, as illustrated in part (c) of FIG. 6, when the traveling controller 7 determines that the traveling wheel 31c of the front-side traveling unit 3A has been brought into contact with the tread F2, the traveling controller 7 detects again step information by the information detection section, and compares a numerical value of a length of the tread F2 with a threshold value stored in advance. In part (c) of FIG. 6, the traveling controller 7 selects and executes the revolution driving processing. Thus, the traveling controller 7 temporarily stops the rotational driving of the traveling wheels 31, and revolves the front-side traveling unit 3A in the direction of the arrow R while maintaining a state of the traveling wheel 31c of the front-side traveling unit 3A being in contact with the tread F2 of the second step. Accordingly, the traveling wheel 31a of the front-side traveling unit 3A, which has been in contact with the tread F1 of the first step, is separated from the tread F1, and simultaneously, the traveling wheel 31b descends toward the tread F2 of the second step, and the drive shaft 30 of the front-side traveling unit 3A moves with the traveling wheel 31c serving as a center of rotation. Thus, the device frame 2 advances in the direction of the arrow A. Rotation control of the traveling wheel 31c at the time of the revolving of the traveling unit is performed in the same manner as in the case of part (c) of FIG. 5, and accordingly, while the traveling wheel 31c of the front-side traveling unit is caused to stay on the tread F2 of the second step, the traveling unit 3A can be revolved, and hence the posture of the device frame 2 descending the stairs can be stabilized. In a case of a tread having a length shorter than that of the tread F1 described in this embodiment, from the state illustrated in part (c) of FIG. 5, in which the traveling controller 7 has executed the revolution driving processing, the traveling wheel 31c may not be brought into contact with the tread F1, but may be brought into contact with the tread F2 of the step below the tread F1. In this case, unlike the state illustrated in part (a) of FIG. 6, the traveling controller 7 continuously executes the revolution driving processing without stopping the revolving of the traveling unit.

Meanwhile, in the state illustrated in part (b) of FIG. 5, the traveling controller 7 may execute the traveling processing. The traveling processing is executed in accordance with the length of the tread F1 and a height of the riser surface U2 below the tread F1, which are pieces of step information detected by the information detection section. The traveling processing is a process to be performed as a stage prior to the stage of descending the traveling unit to the tread F2 of the lower step from the state illustrated in part (b) of FIG. 5, and under a state in which the front and rear traveling wheels of the same traveling unit are respectively in contact with ground contact surfaces having different heights, the traveling unit is slightly advanced. This traveling processing is effective in a case in which, when the traveling controller 7 executes the revolution driving processing under the state illustrated in part (b) of FIG. 5, the traveling wheel 31c is not brought into contact with the tread F1, and is also not brought into contact with the tread F2 of the step below the tread F1. When the revolution driving processing is executed under such a state, the traveling wheel 31c would be brought into contact with the riser surface U2 in a state of being separated away from the tread F2, and hence the electric wheelchair 1 would become unstable. Thus, when the traveling unit is slightly advanced under the state illustrated in part (b) of FIG. 5, and then the revolution driving processing is executed, the traveling wheel 31c can be brought into contact with the tread F2 of the lower step along with the revolving of the traveling unit. A distance by which the traveling unit is to be advanced is determined in accordance with the length of the tread F1 and the height of the riser surface U2 below the tread F1.

Further, when a leading traveling wheel 31a of the rear-side traveling unit 3B has reached the stairs, the same drive control as that in the front-side traveling unit 3A is also applied to the traveling unit 3B.

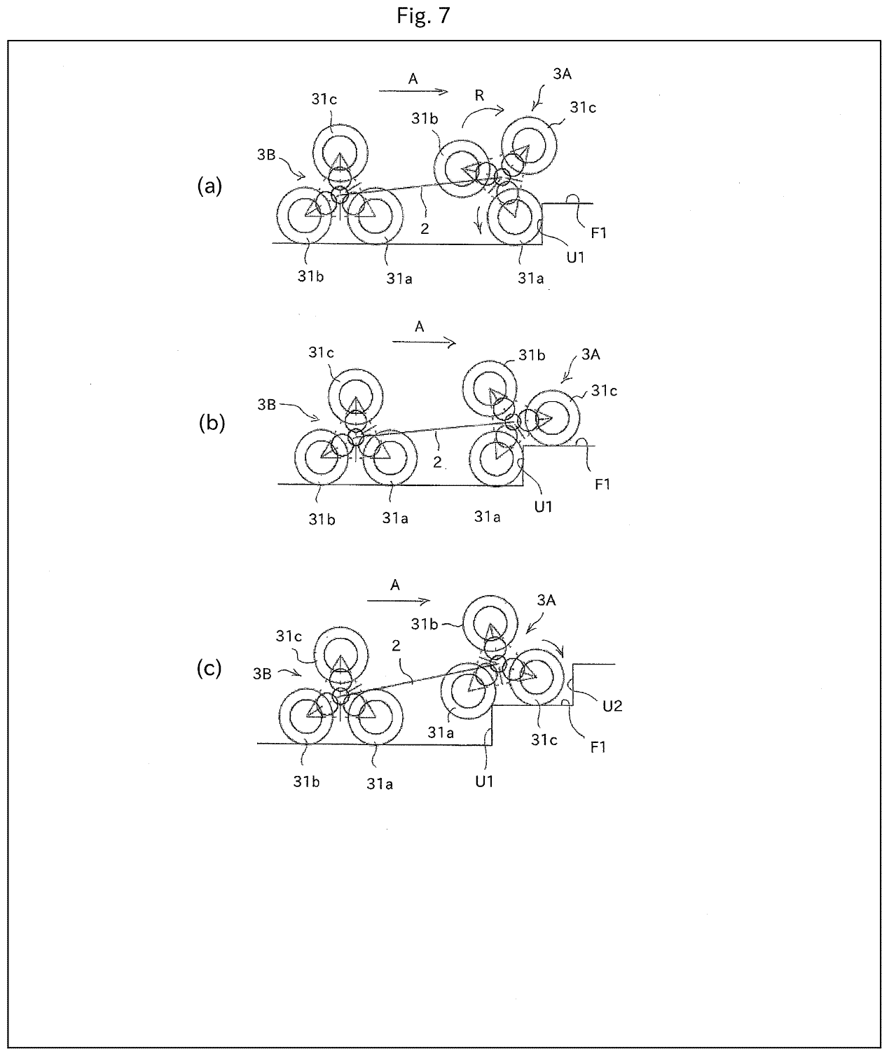

FIG. 7 is a schematic view for illustrating states of traveling units 3A and 3B and traveling wheels 31 included in each of the traveling units 3A and 3B at the time when the electric wheelchair 1 of this embodiment ascends the stairs.

FIG. 7 shows states in which the device frame 2 is ascending from a flat road surface to a first step from the bottom of stairs. As illustrated in part (a) of FIG. 7, when the device frame 2 advances in a direction of the arrow A, and the leading traveling wheel 31a of the front-side traveling unit 3A abuts against a riser surface U1 of the first step from the bottom of the stairs, the traveling controller 7 temporarily stops rotational driving of the traveling wheels 31, and revolves the front-side traveling unit 3A in a direction of the arrow R while maintaining a state of the traveling wheel 31a of the front-side traveling unit 3A being in contact with the riser surface U1 of the first step. Accordingly, the traveling wheel 31b of the front-side traveling unit 3A, which has been in contact with the road surface below the stairs, is separated from the road surface, and simultaneously, the traveling wheel 31c descends toward a tread F1 of the first step, and the drive shaft 30 of the front-side traveling unit 3A moves with the traveling wheel 31a serving as a center of rotation. Thus, the device frame 2 advances in the direction of the arrow A. Although description has been given above of maintaining the state of the traveling wheel 31a of the traveling unit 3A being in contact with the riser surface U1 of the first step, it is not always required that the traveling wheel 31a be in contact with the riser surface U1. As long as the traveling wheel 31c can descend toward the tread F1 of the first step, a gap may be defined between the traveling wheel 31a and the riser surface U1. The traveling controller 7 determines whether or not the traveling wheel 31c can descend toward the tread F1 of the first step, based on an image captured by the camera 5.

Further, when the traveling controller 7 revolves the traveling unit 3A, the traveling controller 7 rotationally drives the traveling wheels 31 included in the traveling unit 3A in a direction opposite to a revolution direction R, and by the same angle as a revolution angle of the traveling unit 3A. At the time of revolving of the traveling unit 3A, when the traveling wheels 31 included in the traveling unit 3A are kept in a stop state, the traveling wheel 31a tends to go up the riser surface U1 in response to the revolving of the traveling unit 3A, and hence there is a risk in that the entire traveling unit 3A may unintentionally swing up and down along the riser surface U1, resulting in becoming unstable. In order to avoid this risk, rotation control of the traveling wheels 31 as described above is required. Accordingly, at the time of the revolving of the traveling unit 3A, when the traveling wheel 31a is rotationally driven in the direction opposite to the revolution direction of the traveling unit 3A, the traveling wheel 31a is brought into a state of staying on the road surface, and hence, the posture of the device frame 2 can be stabilized regardless of the revolving of the traveling unit 3A. When the traveling unit 3A is revolved, the traveling wheels 31 included in the rear-side traveling unit 3B are brought into a state of the free rotation, and hence roll on the road surface in accordance with advancing of the device frame 2 in the direction of the arrow A.

When the traveling controller 7 determines that the traveling wheel 31c has been brought into contact with the tread F1 of the first step along with the revolving of the traveling unit 3A, the traveling controller 7 detects step information by the information detection section. The traveling controller 7 compares a numerical value of a length of the tread F1, which is a piece of step information, with a threshold value stored in advance. This threshold value is determined based on an arrangement interval between the traveling wheel 31a and the traveling wheel 31c, and a size of the traveling wheel, and is a numerical value of a length that allows both of the traveling wheel 31a and the traveling wheel 31c to be placed on the tread. As a result of the comparison, the traveling controller 7 selects any one of traveling processing for advancing of the traveling unit, and revolution driving processing for moving the traveling unit to a different step, to execute the selected processing. As illustrated in part (b) of FIG. 7, in the traveling processing, when the traveling wheel 31c is brought into contact with the tread F1 of the first step along with the revolving of the front-side traveling unit 3A, the traveling controller 7 changes setting of the traveling unit 3A from the revolving in the direction of the arrow R to the free rotation, stops the reverse rotation of the traveling wheels 31 included in the traveling unit 3A, and rotationally drives those traveling wheels 31 in the normal direction. Accordingly, the traveling wheel 31c of the front-side traveling unit 3A advances on the tread F1 of the first step toward a riser surface U2, and thus the entire traveling unit 3A is pulled up onto the tread F1 of the first step.

When the traveling wheel 31c advances on the tread F1 of the first step, and abuts against the riser surface U2 of a second step from the bottom of the stairs, the traveling controller 7 temporarily stops the rotational driving of the traveling wheels 31, and revolves the front-side traveling unit 3A in the direction of the arrow R while maintaining a state of the traveling wheel 31c of the front-side traveling unit 3A staying on the tread F1 of the first step. Accordingly, the traveling wheel 31a of the front-side traveling unit 3A is separated from the road surface, and simultaneously, the traveling wheel 31b descends toward the tread F2 of the second step, and the drive shaft 30 of the front-side traveling unit 3A moves with the traveling wheel 31c serving as a center of rotation. Thus, the device frame 2 advances in the direction of the arrow A. Rotation control of the traveling wheel 3c at the time of the revolving of the traveling unit is performed in the same manner as in the case of part (a) of FIG. 7, and accordingly, while the traveling wheel 31c of the front-side traveling unit is caused to stay on the tread F1 of the first step, the traveling unit 3A can be revolved, and hence the posture of the device frame 2 ascending the stairs can be stabilized.

Meanwhile, under the state illustrated in part (b) of FIG. 7, as a result of having compared a numerical value of a length of the tread F1, which is a piece of step information, with a threshold value stored in advance, the traveling controller 7 may execute the revolution driving processing. In a case of the revolution driving processing, subsequently to the revolving of the traveling unit at the time when the leading traveling wheel 31a of the front-side traveling unit 3A has abutted against the riser surface U1 of the first step from the bottom of the stairs, the revolving of the traveling unit is further executed. In this case, the traveling wheels 31 are rotationally driven in the direction opposite to the revolution direction R, and by the same angle as a revolution angle of the traveling unit 3A. Accordingly, under a state of the traveling wheel 31c being in contact with and staying on the tread F1, the traveling wheel 31b passes over the tread F1 in an arc, and descends to a tread of a step above the tread F1. This revolution driving processing is more effective in a case in which, as a result of having compared a numerical value of the length of the tread F1, which is a piece of step information, with a threshold value, the numerical value of the length of the tread F1 is smaller than the threshold value.

Further, when the leading traveling wheel 31a of the rear-side traveling unit 3B has reached the riser surface U1 of the first step, the same drive control as that in the front-side traveling unit 3A is also applied to the traveling unit 3B. Accordingly, the device frame 2 can stably ascend steps of the stairs one by one.

As described above, according to the electric wheelchair 1 of this embodiment, in the case of ascending and descending steps such as stairs, by using the traveling units 3, each of which includes the three traveling wheels 31 radially arranged therein, and which can drive and revolve those traveling wheels 31, when the traveling controller 7 controls driving and revolving of the traveling units 3, the traveling controller 7 rotationally drives the traveling wheels at the same angle of rotation as that of the driving and revolving of the traveling units 3, in the direction opposite to the revolution direction of the traveling units 3. With this configuration, each of the traveling units 3 can be driven to revolve while one of the traveling wheels, which has been in contact with a tread, stays on the tread. For this reason, there is no fear in that, during the revolving of the traveling unit, the traveling wheel may unintentionally travel, and fall onto a tread below the step. Accordingly, the traveling units are stably revolved, and hence the posture of the device frame including the traveling units can be stabilized. Thus, this electric wheelchair 1 can ascend and descend steps such as stairs in a stable posture with an occupant being carried on the electric wheelchair 1. Further, when it is configured that, on condition that one of the traveling wheels included in each of the traveling units 3 is continuously in contact with both of the riser surface and the tread of the step, the driving and revolving of the traveling unit 3 is performed, the electric wheelchair 1 can ascend and descend steps such as stairs in a more stable posture.

Moreover, the traveling controller 7 can control the electric wheelchair 1 so that the electric wheelchair 1 faces the edge of the step. Accordingly, stability in a case of straight stairs can be ensured, and in addition thereto, even in a case of curved stairs, one of the right and left traveling units provided to the electric wheelchair 1 can be prevented from falling onto an unintended tread. In this case, with the adoption of the Mecanum wheel, a direction of the electric wheelchair 1 can be easily changed, and hence the electric wheelchair 1 can be easily caused to face the edge of the step. Further, with the adoption of the Mecanum wheels as the traveling wheels 31 included in each of the traveling units 3 provided on the front and rear, and right and left sides in the device frame 2, even while ascending or descending the stairs, when a rotation direction of the Mecanum wheels in each of the traveling units is controlled, the device frame can be moved laterally in the right-and-left direction. Thus, the electric wheelchair 1 can ascend and descend the stairs while avoiding obstacles present in the middle of the stairs.

In this embodiment, specific description has been given of the example in which the step ascending/descending device of the present invention is applied to the electric wheelchair 1. However, when the seating frame 4 is replaced with a loading platform frame, the present invention can also be applied to applications, such as carrying of a package, other than a wheelchair.

1. A step ascending/descending device, comprising:
traveling units, each of which includes three traveling wheels arranged at equal angular intervals around a rotary shaft of the traveling units, and which are configured to revolve the traveling wheels around the rotary shaft, each of the traveling wheels being configured to travel on a floor surface by being rotated on an own axis of the traveling wheel;
a device frame including at least a pair of the traveling units provided on right and left sides in the device frame, respectively;
a traveling drive source configured to rotationally drive the traveling wheels;
an ascending/descending drive source configured to drive and revolve the traveling units; and
a traveling controller configured to control operations of the traveling drive source and the ascending/descending drive source,
the step ascending/descending device being configured to ascend and descend a step while revolving the traveling units,
wherein, at the time of driving and revolving the traveling units, the traveling controller is configured to rotationally drive the traveling wheels at the same angle of rotation as a revolution angle of the traveling units in a direction opposite to a revolution direction of the traveling units.

2. The step ascending/descending device according to claim 1, wherein, on condition that one of the traveling wheels included in each of the traveling units is continuously in contact with both of a riser surface and a tread of the step, the traveling units are configured to be driven to revolve.

3. The step ascending/descending device according to claim 1, wherein the three traveling wheels included in each of the traveling units are Mecanum wheels serving as omnidirectional wheels.

4. The step ascending/descending device according to claim 1, wherein, under a state in which the device frame faces an edge of the step, the traveling controller is configured to perform the ascending and descending the step.
